(19) United States
(12) Patent Application Publication
(10) Pub. No.: US 2008/0059179 A1
(43) Pub. Date: Mar. 6, 2008

(54) METHOD FOR CENTRALLY STORING DATA

(75) Inventor: Roger Lagadec, Regensdorf (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/850,881

(22) Filed: Sep. 6, 2007

(30) Foreign Application Priority Data
Sep. 6, 2006 (EP) 06120191

(51) Int. Cl. G10L 15/00; G10L 13/00

(52) U.S. Cl. 704/251; 704/270.1; 704/E13.001

(57) ABSTRACT

A method is disclosed for centrally storing data in a remote server (4). On the remote server (4), a voice memo (42) that has been recorded by a user (1) and converted into a text with the aid of a voice recognition system (13, 43) is stored as a text. The memory area (42) is user-specific, and the user (1) is previously identified in the remote server (4). Simultaneously, the contents of the memory area (42) can be searched by the user (1) for a particular item of information. The invention is characterized in that additional data are transmitted over an interface (14, 24) working at close range to a telecommunication device (11) of the user (1) and over the telecommunication device (11) to the remote server (4), and additionally stored in the memory area (42) allocated to the user (1). The invention also relates to a remote server (4) with equivalent characteristics.

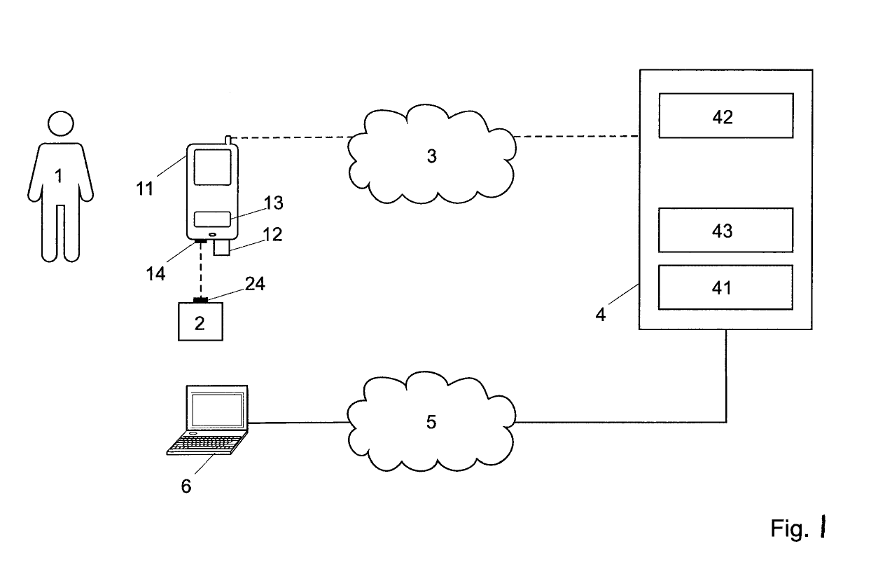

### REFERENCE DATA

This application claims priority from European patent application 2006EP-120191 of Sep. 6, 2006, the contents whereof are hereby incorporated.

### TECHNICAL FIELD

The invention relates to a method for storing data centrally and in text-based manner in a remote server, on a remote server and on a telecommunication device according to the independent claims.

### BACKGROUND OF THE INVENTION

DE-A1-199 53 813 discloses an installation that consists of an access to a public communication network, an algorithm for voice recognition, a data processing unit, a database for data storage, a system clock as well as a terminal, and that processes telephone calls over a voice recognition algorithm in such a manner that person resp. performance bound conversation protocols are established and stored. There is also the possibility of recording a remote dictation. Simultaneously, a key word search function of a normal text processing system is mentioned in order to allow the user to search a protocol thematically according to the conversation contents.

US-A1-2005/0159959 discloses a central, network-based voice memo recorder that includes a voice recognition function and that records conversations, and converts the voice message thus generated into a text message. The text message is made available to the user so that he receives a protocol of the conversation. The activation occurs over a special key, a menu or a voice command.

EP-A2-1 225 754 discloses a central server for voice messages, where the storing from a GSM or Internet terminal during a spoken dialogue is disclosed and that includes an automatic voice recognition and additional metadata, including the time and emotions. It is however a disadvantage that these messages are stored as audio files and not as text.
DE-A1-103 30 799 discloses a device for storing memos. This can occur for example as a box hanging on a wall in a kitchen or also as a mobile telephone. The embodiment given by way of example includes a voice recognition program in order to convert the spoken contents into text. The converted text can be displayed, printed or forwarded as SMS or email. There is however the disadvantage that no central data storing and no search possibilities are disclosed.

U.S. Pat. No. 6,029,063 discloses a network-based “Voice scratchpad”, in particular for storing voice contents during a telephone connection or if the mobile telephone is in standby mode. U.S. Pat. No. 6,038,441 discloses the recording of a voice memo for use within a car with a local storage. It is also possible to store external incoming calls.

WO-2A1-01/848815 discloses a network-based memo dictation device with a separate connection to the memo server. U.S. Pat. No. 6,671,353 discloses a local dictation device in the mobile telephone with a special key for recording voice during a connection.

### REPRESENTATION OF THE INVENTION

It is an aim of the invention to propose a method, a server and a telecommunication device that differs advantageously from the embodiments known in the prior art and can store additional data relevant to the user in a remote server.

According to the invention, this aim is achieved by a method according to the preamble of claim 1 in that the data collected with said telecommunication device are sent to a remote server and additionally thereto are stored in a memory area allocated to the user.

According to the invention, this aim is also achieved by a system with the characteristics of the independent device claims.

In particular, the inventive aims are achieved by a remote server according to the preamble of claim 16, characterized in that the received user-specific data that have not been generated by the voice recognition system are stored additionally in the memory area allocated to the user.

This aim is also achieved through a telecommunication device with the following characteristics:
means for recording a voice memo;
means for identifying the user vis-à-vis the remote server, where there is a memory area allocated to the user;
means for forwarding a voice memo to a remote server;
an interface working at close range in order to transmit data to the telecommunication device;
a program that causes the reception of said data over the interface working at close range, the identification of the user vis-à-vis the remote server and the forwarding of the data into the memory area of the remote server allocated to the user.

Advantageously, with the present invention the user can integrate in his memory area apart from voice memos further data he receives over his telecommunication device It is possible to access to retrieve and search these data, which can pertain to things of everyday life such as for example a purchase made. It is advantageous if the storing occurs automatically or semi-automatically through a program or applet loaded in the telecommunication device. Said Java-applet or program is in charge of receiving the data in the telecommunication device, identifying the user vis-à-vis the remote server and forwarding the data to the remote server, where the user, e.g. by pressing on a key or voice command, only has to enter an <ok> for the entire transaction.

Further advantageous embodiments are indicated in the sub-claims.

### SHORT DESCRIPTION OF THE FIGURES

The invention will be described in more detail on the basis of the attached figures, where the single FIGURE shows a system according to the present invention.

### WAYS OF EXECUTING THE INVENTION

According to the invention, a method is disclosed for centrally storing voice memos converted into text and further data in a remote server 4 by a user 1. In the illustrated embodiment, which is represented in the single FIGURE, the user 1 is equipped with a mobile telephone, a PDA, a Playstation, a laptop or another telecommunication device 11 that is connected to a communication network 3. An identification module 12 is provided for identifying the telecommunication device 11 in the communication network 3, in the example indicated it is a SIM card in a mobile device in a mobile radio network. The identification module 12 can be removed (as a SIM card in a mobile telephone) or be built-in permanently. Different communication networks 3 are known from the prior art, for example a GSM-, GPRS, HSCSD, EDGE, UMTS, CDMA network or cable TV or IP network, over which data can also be transmitted. Equivalent communication networks 3 can however also be used in the frame of the invention.

The remote server 4 is operated for example by the operator of the communication network 3 or by another service provider. It has a memory area 42 that is allocated to different users 1 and used by them. Each user, after a successful identification, can access his own part of the memory area 42 and on the texts and data stored there or leave his texts and data there. The remote server 4 is also connected with said communication network 3 or over the Internet 5 with the communication network 3.

In order to access his memory area 42 and be able to store data or texts or search the stored data and texts, each user 1 must however in a first step be identified vis-à-vis the remote server 4. Identification can occur via said identification module 12 of the telecommunication device 11, via a caller identification (Caller-Line-Identification CLI), via biometric parameters (fingerprints, iris or retina scan, etc.) and/or via a password vis-à-vis the remote server 4. It is also known that the voice of the user 1 can be used as biometric parameter if the user records a voice memo or communicates with the system through a voice-operated menu. In this manner, it is possible to distinguish between several users of a device or of an identification module, for example in a family or if several persons speak in a conversation. The identification of the user 1 can depend on the device used, as it is conceivable to offer the user further access to the remote server 4 and to his personal memory area 42. In the single FIGURE, the remote server 4 is additionally connected with the Internet 5 and an Internet terminal 6. The user identification vis-à-vis the remote server 4 can also depend on the device 11, 6 and, in one embodiment, is chosen and set by the user 1 in personal settings. The Internet terminal 6 can be provided with an identification module 12.

In a first step, the described system knows the function of recording voice memos of the user 1. The user 1 can easily use his telecommunication device 11 for this by connecting with the remote server 4, being identified vis-à-vis the remote server 4 and confirming a recording function. The user connects with the system, records the things he wishes to records and stores these in his personal memory area 42. It is also possible to record conversations in the vicinity of the telephone, telephone calls made with the telecommunication device, conferences or other voice messages, which are then stored by the user 1 in the remote server 4. Telephone conversations are either recorded systematically, or only if a corresponding command, for example over DTMF or as voice command is entered by one of the participants. It is also possible that the recording begins automatically if certain conditions are fulfilled, for example if certain words are spoken or certain numbers are called. The dialogue with the IVR (Interactive Voice Response System) in the remote server can be heard for both participants or only for the participant who has instructed the remote server, this decision being made with a command from the participant. Furthermore, it is possible to record either only what has been spoken by the owner of the telecommunication device or what has been spoken by all participants in the conversation. It is also possible that several participants record simultaneously and separately a dialogue in the same remote server.

In order to make the stored data searchable, there is either in the telecommunication device 11, in the remote server or in another part of the communication network 3 a voice recognition system 13, 41 that analyzes the recorded voice memo and converts it into text. The text generated in this manner is stored in a memory area 42 of the remote server 4 allocated to the user 1. The user can also use the Internet terminal 6 for recording the voice memo and/or the conversation.

The used voice recognition system 13, 41 can use user-dependent language models that have been previously generated and stored centrally. Since the user 1 is identified in every case, it is possible to revert to the stored, user-dependent language models. Thanks to newly recorded voice memos of the user 1, it is possible to simultaneously develop new language models for the user. By identifying the user and using user-dependent language models, the reliability of the voice recognition can advantageously be increased. The automatic recognition of the language simultaneously allows the language recognition system 13, 41 to be used independently of the used language.

The recording procedure in the memory area 42 can be initiated in different ways. In a simple embodiment, the user selects a number that connects him with the remote server 4. It is also conceivable that a preprogrammed key on the telecommunication device 11 is provided for activating resp. deactivate the recording function or other functions within the remote server 4.

In another embodiment, the user 1 must install a Java-applet or another small program on his telecommunication device 11 before he can use the service. This program offers the user 1 a menu or a voice menu in order to reach the service's different functions. It is possible to access from different devices the user's own account stored on the remote server 4. Access over the Internet 5 and thee computer 6 is also conceivable.

According to the invention, in addition to the voice memos converted into text, data are transmitted over an interface 14, 24 working at close range to the telecommunication device 11 of the user 1 and sent over the telecommunication device 11 to the remote server 4. These data are also stored in the memory area 42 allocated to the user 1. It is advantageous for this to occur automatically or semi-automatically. Said Java-applet or program is in charge of receiving the data in the telecommunication device and forwarding them to the remote server 4. If the program can access data in the identification module 12 or other identification data of the user 1, the program can simultaneously perform the identification of the user 1 vis-à-vis the remote server 4. In this case, the user simply enters an <ok> in his telecommunication device for receiving and forwarding the relevant data. In another embodiment, the user enters his password for identification and then enters his <ok>. The program can also record metadata, which will be explained in more detail further below, in the telecommunication device 11 and cause the metadata to be forwarded together with the data to the memory area 42 of the remote server 4 allocated to the user 1.

As interface working at close range, a large number of interfaces are known to the one skilled in the art, such as Bluetooth, infrared, HomeRF, NFC (Near Field Communication), W-LAN etc. Other equivalent interfaces known in the prior art can also be used for the invention. Wireless or also wired interfaces (such as USB) are conceivable within the frame of the invention. Activating the connection and initiating the transmission to the server can in principle originate from both parties, the telecommunication device 11 or the external device 2 of the participating third party and also include an active authorizing of the user 1 by pressing on a key, menu selection or voice command. A mode in which a telecommunication device continuously scans external devices and searches for information that fulfill predetermined criteria for a transmission to the remote server is also conceivable.

In one embodiment, for additional data, receipts or cash receipt vouchers for performed transactions or bought goods are transmitted from a point of sale to the telecommunication device 11. The cash receipts show a detailed inventory of the bought goods. If these receipts are stored, the user can advantageously revert to the data at a later point in time and search these in the memory area for the voice memos. If he is no longer sure which goods he bought the last time, he can simply search in the shop where he connects to his memory area 42 over the telecommunication device 11. The external device 2 in this case is the shop till that transmits the data to the telecommunication device 11. Another example such as the transmission of the working hours from the external device 2 over the interface 14, 24 to the telecommunication device 11 are conceivable, so that no further time recording is necessary. Another example is the storing of ring tones, logos of broadcast SMS or other data that are sent to the telecommunication device 11 over the interface 14, 24 at close range. If the user finds himself in front of an advertisement billboard and is connected with this billboard over Bluetooth, etc. he can receive this advertisement over this billboard in his mobile telephone and also store it in the remote server 4.

Documents that arrive in the server 4 over a contactless interface 14, 24 and the user device 11 are preferably in text format or in another searchable format or are converted into such a format. Data that are received over an interface 14, 24 can also be linked with voice memos that are already available in the remote server 4 or with newly generated voice memos and stored as a kind of attachment.

Furthermore, it is conceivable in a further embodiment to send further data that are available to the user or his telecommunication device to the remote server and to store them in the memory area 42 of the remote server 4. These data include for example copies of all sent or received SMS, MMS, e-mails, photographs that have been taken with the camera of the telecommunication device 11, the telephone directory of the user 1 in the telecommunication device 11 or also entries in a calendar in the telecommunication device 11, or measurements from sensors in the telecommunication device 11. Information that are determined within the network can also easily be stored in the remote server 4. These contain among others indications about incoming or outgoing calls, the costs of these connections, the starting and ending times, duration, state of the user (busy/unavailable/in roaming etc.), other information from the CDRs (Call Detail Records), visited websites, indications about connections established over Bluetooth or VoIP etc.). Messages that are stored for the user 1 in a personal network-based voice message box (Voicemail) 43 can also be stored in the remote server 4 or be copied thereto. In the single FIGURE, the network-based voice message box 43 is also located in the remote server 4. This is however not absolutely necessary and it can also be in any other part of the communication network 3 or in the user device.

As the user 1 can also connect with the remote server 4 over a computer 6 and the Internet 5, data that are generated or stored in the computer 6 can in principle be copied into the memory area 42 automatically or upon confirmation of the user. These could thus be data (e-mails, address book, calendar function etc.) of an e-mail program, general text documents, data from a VoIP service of the user 1 and/or data originating from an Internet chat.

In order to store all the texts and data, different possibilities are available within the frame of the invention. In a first embodiment, all documents are converted into a searchable format, for example text, including XML, and stored, so that the formation can easily be searched. Simultaneously, the associated audio file *.wav, *.mp3 etc. belonging to the text is stored in the memory area 42. The user 1 thus has the possibility of listening once again to the document at a later point in time if necessary. In a further embodiment, the associated audio file is stored only in the memory area if there are doubts during the voice recognition as to the correctness of the recognized text. Simultaneously, it is possible to attribute different metadata to the stored documents and to store them together. As metadata, are suitable for example the date, start time, duration and location of the recording, the outside temperature on that day, or the used recording device. The location can be determined itself in the terminal, for example with a GPS receiver, or in the telecommunication network. The mood or frame of mind of the user 1 can additionally be associated to the text. If voices of several persons are stored in a memory area (for example participants to a telephone conversation), the system can also distinguish these people from one another and store a corresponding indication (“Participant 1 says:”). The user can also name the persons and the system can learn how the corresponding participant 1 is called.

Individual files can be marked with a watermark, which makes the search for the document easier or can prove the origin or authenticity of the document. The data received over the interface 14, 24 can also be provided with a time stamp or an electronic signature (as metadata).

All documents can be stored in principle unorganized, for example chronologically in the order they were recorded, or depending on different criteria (size of the document, transmission costs, available memory space etc.). It is thus no longer necessary to have a relational or complex database system. The possibility is additionally given to the user to edit the stored texts and data from his mobile device 11 or PC 6 and to classify them as he wishes. The documents can also be indexed or subscripted.

In all mentioned embodiments, the user 1 has the possibility of indicating in a user profile the settings he desires in relation to the storage of the data. The user can also provide different texts and data with different access rights for different persons or groups. In this manner, the user can selectively give his family, his friends or his work colleagues the authorization to access the stored data. These persons can log into the remote server in the same manner as the user 1: through a telecommunication device 11 over a communication network 3 or through a computer 6 and the Internet 5. Access to the documents in the remote server 4 is thus also always possible even if the user has lost his telecommunication device 11 or if it has been damaged. Some documents can also be marked as secret or only accessible to the user so that no other persons but the user 1 himself can access these documents.

For the search, different possibilities are available according to the invention. The user can activate a search engine with the telecommunication device 11 or the computer 6 and search the documents in his memory area on the basis of keywords. Keywords allow not only the contents of the stored documents to be searched but also said metadata (for example the time or location) that characterize these data. The search engine will preferably be operated by the operator of the server and indexes only the documents in this server. A user can only search for documents that are contained in his personal memory area or at least for documents for which he has reading access rights.

The search engine can also have a voice-controlled menu. This possibility offers itself in particular if a voice channel is available that can be used by the user 1. Access to the data can occur manually at a point in time chosen by the user when he searches for a particular item of information. An automatic or semi-automatic access can also be provided. In this case, an alarm function could remind the user about a deadline or it could be a criteria (e.g. location or event) preset by the user. This access can be indicated by the user for example in the user options. In a further embodiment, access to the data can also occur over the network-based voice message box 43.

The data of a calendar program such as Outlook can be stored in the remote server 4 resp. the remote server 4 can be synchronized with a calendar program such as Outlook. As long as the location of the recorded documents is known, they can be processed geographically and represented on a map and questions such as “What memo did I record in Kreuzberg? Where is my KaDeWe receipt? How expensive was the coffee in Venice?” can be answered more easily with the aid of the map.

From the mobile device 11, the user 1 can access his data and browse through them over a voice-controlled menu, over a WAP function, by sending an SMS etc. The results can be received as text (WAP, SMS, USSD, etc.) and displayed to the user. If an audio file is available, the user 1 can play this original file with the originally recorded information. A text file can also be synthesized with the voice of the user or another, possibly known or famous voice. Use of a computer 6 will give additional possibilities. The user can access a search result over an Internet site or it can be sent to him as e-mail. In principle, the data can be represented here too as text or (if available) as audio file.

Use of the personal memory area 42 for storing the text and the data can be billed to the user by a service provider. The manner in which the costs are billed can differ. One possibility consists in a comprehensive fee for using the service, e.g. as part of his monthly subscription for the telecommunication device 11. A billing according to the used memory space or only for the transmitted data volumes when storing or searching and playing back the data is conceivable. In another embodiment, there is a fixed fee for each sent or played back message. Depending on a user profile, according to one or several performed searches or depending on the contents of a stored text or of the stored data, it is possible in a further embodiment to send the user some advertising.

The remote server 4 with an IVR system can also be called by the user in order to access additional, possibly user-specific services and applications. A central calendar program, in which appointments are entered over voice commands or that notes appointments automatically based on the contents of the voice memos, is also possible. As a further interesting application, one can consider a central, network-based call assistant with which calls can be established, telephone directories managed and voice messages listened to. Accessing these additional functions can for example occur over special voice commands. It is particularly advantageous if these additional applications can also access the contents of the voice memos and the extended searching possibilities of the remote server; commands such as “please call the number in the voice memo of yesterday afternoon” or “I had a meeting in Bern last week; can you please read the corresponding voice memo?” can be entered and be correctly interpreted by the remote server.

Besides the method, the invention also relates to a remote server and a telecommunication device with the characteristics of the independent device claims.

### LIST OF REFERENCES

1 User
11 Telecommunication device
12 Identification module
13 Voice recognition system
14 Interface working at close range
2 External device
24 Interface working at close range
3 Communication network
4 Remote server
41 Voice recognition system
42 Memory area
43 Voice message box of the user 1
5 Internet
6 Computer, Internet terminal

1. Method for centrally storing data in a remote server, having the following method steps:
(a) a voice memo is recorded by a user with a telecommunication device of the user,
(b) the voice memo is converted into a text with the aid of a voice recognition system;
(c) the user is identified in the remote server, different memory areas of the remote server being allocated to different users and
(d) the generated text is stored in the memory area of the remote server allocated to the user, the contents of the memory area being searchable by the user for a specific item of information,
characterized in that
(e) data collected with said telecommunication device are sent to the remote server and additionally thereto stored in the memory area allocated to the user.

2. The method of claim 1, characterized in that said collected data are transmitted first over an interface working at close range to the telecommunication device of the user.

3. The method of claim 1, characterized in that a program loaded in the telecommunication device causes said data to be received, the user to be identified vis-à-vis the remote server and the data to be forwarded to the memory area of the remote server allocated to the user.

4. The method of claim 1, characterized in that further data that are available to the user or to his telecommunication device are sent to the remote server and stored in the memory area of the remote server allocated to the user.

5. The method of claim 4, characterized in that these data include SMS, MMS, e-mails, photographs, reports about the activities of the telecommunication device, message in a network-based voice message box of the user, measurement data from sensors of the telecommunication device and/or data from a VoIP service of the user.

6. The method of claim 1, characterized in that the text and the additional data are stored with metadata.

7. The method of claim 1, characterized in that different texts and data are provided with different access rights for different persons or groups.

8. The method of claim 1, characterized in that the user is identified vis-à-vis the remote server via an identification module of the telecommunication device, via a caller identification, via biometric parameters and/or via a password.

9. The method of claim 1, characterized in that the user uses his telecommunication device or an Internet terminal for searching for and/or recording the voice memo.

10. The method of claim 1, characterized in that the voice recognition takes place in the telecommunication device of the user or in the remote server.

11. The method of claim 1, characterized in that the converted text is stored with an associated audio file in the memory area.

12. The method of claim 1, characterized in that the converted text is stored only with an associated audio file in the memory area if the voice recognition has doubts as to the correctness of the recognized text.

13. The method of claim 1, characterized in that the storing of the text and of the data is billed to the user by a service provider.

14. The method of claim 1, characterized in that the user receives advertisements corresponding to one or several performed searches or depending on the content of a stored text or of stored data.

15. The method of claim 1, characterized that Bluetooth, infrared, HomeRF, NFC, WLAN is used as interface working at close range.

16. Remote server with the following characteristics:
(a) a connection to a communication network;
(b) means for identifying different users;
(c) different memory areas of the remote server that are allocated to different users, the contents of the memory area being searchable by the user for a specific item of information;
(d) text generated in a voice recognition system and stored in a memory area,
characterized in that
(e) received user-specific data that are not generated by the voice recognition system are stored additionally in the memory area allocated to the user.

17. The remote server of claim 16, characterized in that the voice recognition system is located in the remote server.

18. Telecommunication device characterized by the following characteristics:
means for recording a voice memo;
means for identifying the user vis-à-vis the remote server, where there is a memory area allocated to the user;
means for forwarding a voice memo to a remote server;
an interface working at close range in order to transmit data to the telecommunication device;
a program that causes the reception of said data over the interface working at close range, the identification of the user vis-à-vis the remote server and the forwarding of the data into the memory area of the remote server allocated to the user.

19. The telecommunication device of claim 18, characterized in that the program offers the user a menu or a voice menu for being able to reach different functions within the remote server.

20. The telecommunication device of claim 18, characterized in that the program records metadata in the device and causes the metadata to be forwarded together with the data in the memory area of the remote server allocated to the user.

21. The telecommunication device of claim 18, characterized in that the telecommunication device has a voice recognition system.
